(19) United States
(12) Patent Application Publication
(10) Pub. No.: US 2008/0290721 A1
(43) Pub. Date: Nov. 27, 2008

(54) Spoke fastening device for vehicle wheel

(76) Inventor: Yuhju Wang, Taipei (TW)

Correspondence Address: CHARLES E. BAXLEY, ESQUIRE, 90 JOHN STREET, SUITE 309, NEW YORK, NY, 10038, US

(21) Appl. No.: 11/805,145

(22) Filed: May 22, 2007

(51) Int. Cl. B60B 21/06

(52) U.S. Cl. 301/58

(57) ABSTRACT

A spoke fastening device includes a spoke fastening hole drilled through a spoke bed of a wheel rim for receiving a head and a stem of a nipple and a collar of a ferrule, the ferrule includes a casing on one end of the collar for engaging with the spoke bed and having an inner peripheral channel for receiving a sealing ring which may make a water tight seal between the nipple and the ferrule and for allowing the nipple to be tilted or inclined relative to the ferrule, the collar includes a peripheral groove for forming two separated cylindrical segments and for allowing the outer cylindrical segment to be flared by the head of the nipple.

### BACKGROUND OF THE INVENTION

1. Field of the Invention

The present invention relates to a spoke fastening device for a vehicle wheel, such as a wheel for a bicycle or motorcycle, and more particularly to a spoke fastening device including a structure for being easily installed to or disengaged from the vehicle wheel, and including a water tight seal structure.

2. Description of the Prior Art

Typical spoke fastening devices for mounting a spoke on a wheel rim comprise a spoke fastener including a shank having an anchoring portion and an operating portion, the anchoring portion is formed with resilient arm segments that are angularly spaced apart from each other and forcible radially and inwardly toward a central shank axis for allowing the anchoring portion to engage through a spoke fastening hole in a wheel rim.

For example, U.S. Pat. No. 6,779,853 to Chang discloses one of the typical spoke fasteners comprising a fastener shank having an anchoring portion which is formed with resilient arm segments that are angularly spaced apart from each other and that are forcible radially and inwardly toward a central shank axis or toward each other for allowing the anchoring portion to engage through a spoke fastening hole in a wheel rim.

However, for allowing the resilient arm segments of the anchoring portion to engage through the spoke fastening hole in the wheel rim, the anchoring portion of the fastener shank should include a relatively smaller outer diameter than an inner diameter of the spoke fastening hole in the wheel rim, such that the anchoring portion of the fastener shank may not be solidly secured to the wheel rim, or it will be difficult to form a water tight seal structure between the anchoring portion of the fastener shank and the wheel rim.

U.S. Pat. No. 6,811,228 to Tien discloses another typical wheel having a spoke solidly coupling device and comprising a number of couplers and fasteners and lock nuts for coupling or fastening or securing the spokes to the wheel rim, and the couplers each also include a number of slots for forming a number of spring blades and for allowing the spring blades to be engaged through the spoke fastening holes in the wheel rim.

However, similarly, for allowing the spring blades of the couplers to engage through the spoke fastening holes in the wheel rim, the couplers should also include a relatively smaller outer diameter than an inner diameter of the spoke fastening hole in the wheel rim, such that the couplers may not be solidly secured to the wheel rim, or it will be difficult to form a water tight seal structure between the couplers and the wheel rim. In addition, the couplers include a cylindrical shape that may not be engaged with or rotated or driven by the driving tools.

U.S. Pat. No. 6,938,962 to Schlanger discloses a further typical vehicle wheel spoke coupling device or termination and comprising a number of hub flanges or ferrules and connecting elements for coupling or fastening or securing the spokes to the wheel rim, and the hub flanges or ferrules each include a cylindrical collar for engaging through the spoke fastening holes in the wheel rim and for being flared or deformed to create the flared portion and to engage with the wheel rim.

However, the hub flanges or ferrules should be made of deformable metal materials such that the flared portion of the cylindrical collar the hub flanges or ferrules should also be made of deformable metal materials, which will then be engaged with the wheel rim that is also made of metal materials, it will be difficult to form a water tight seal structure between the metal hub flanges or ferrules and the metal wheel rim. In addition, the hub flanges or ferrules include a cylindrical shape that may not be engaged with or rotated or driven by the driving tools.

The present invention has arisen to mitigate and/or obviate the afore-described disadvantages of the conventional spoke fastening devices.

### SUMMARY OF THE INVENTION

The primary objective of the present invention is to provide a spoke fastening device including a structure for being easily installed to or disengaged from the vehicle wheel by the users themselves.

The other objective of the present invention is to provide a spoke fastening device including a water tight seal structure.

In accordance with one aspect of the invention, there is provided a spoke fastening device comprising a wheel rim including a spoke bed, and a spoke fastening hole drilled through the spoke bed and bounded by a peripheral flange, a nipple including a head, and a stem extended from the head and having an outer diameter smaller than an outer diameter of the head, both the head and the stem being engageable through the spoke fastening hole of the spoke bed of the wheel rim, the nipple including a threaded hole formed therein, a ferrule including a collar engaged onto the nipple, and including a casing extended radially and outwardly from one end of the collar for engaging with the spoke bed of the wheel rim and for anchoring the ferrule to the spoke bed of the wheel rim and for allowing said ferrule to be rotated relative to said nipple and said spoke bed of said wheel rim, and including an inner peripheral channel formed in the casing, the collar including a first cylindrical segment adjacent to the casing and engaged in the spoke fastening hole of the spoke bed of the wheel rim, and including a second cylindrical segment located distal to the casing and extended out through the spoke fastening hole of the spoke bed, the head of the nipple being engageable with the second cylindrical segment for flaring and deforming the second cylindrical segment to engage with the spoke bed of the wheel rim, a spoke including a threaded portion engaged with the threaded hole of the nipple for forcing the head of the nipple to engage with and to flare the second cylindrical segment.

The casing of the ferrule includes an inner and inclined peripheral fence and an outer and inclined peripheral fence for forming the inner peripheral channel of the casing.

The inner peripheral fence of the casing is inclined relative to the spoke bed of the wheel rim and in line engagement with the spoke bed of the wheel rim. The inner and inclined peripheral fence of the casing is inclined relative to the collar.

The collar includes a peripheral groove formed therein for forming the first and the second cylindrical segments and for separating the first and the second cylindrical segments from each other. The ferrule includes at least one slot longitudinally formed therein for forming at least one blade.

The slot of the ferrule is formed through a length of the collar and ended at an adjacent portion between the collar and the inner and inclined peripheral fence of the casing. The ferrule includes an opening formed in the adjacent portion between the collar and the inner and inclined peripheral fence of the casing and communicating with the slot of the ferrule.

The nipple includes at least one flat formed in an outer portion, and the ferrule includes a flap bent relative to the second cylindrical segment and engaged with the second cylindrical segment.

A sealing ring may further be provided and engaged in the inner peripheral channel of the casing for engaging with the stem of the nipple and for making a water tight seal between the nipple and the ferrule. The casing of the ferrule includes an inwardly folded rim engaged with the sealing ring and for anchoring and retaining the sealing ring within the inner peripheral channel of the casing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a spoke fastening device in accordance with the present invention;

FIG. 2 is a perspective view of a spoke fastening device in which one half of the spoke fastening device has been cut off for showing an inner structure of the spoke fastening device;

FIG. 3 is a partial cross sectional view of the spoke fastening device;

FIGS. 4, 5, 6, 7 are partial cross sectional views similar to FIG. 3, illustrating the operation of the spoke fastening device;

FIG. 8 is a partial cross sectional view similar to FIGS. 3-7, illustrating the other arrangement or application of the spoke fastening device; and

FIG. 9 is a further partial cross sectional view similar to FIGS. 3-8, illustrating the further arrangement or application of the spoke fastening device.

### DETAILED DESCRIPTION OF THE PREFERRED EMBODIMENT

Referring to the drawings, and initially to FIGS. 1-3, a spoke fastening assembly or device 1 in accordance with the present invention comprises a wheel rim 10 including a “double-wall” construction having an enclosed cavity 12 formed therein and bounded by the sidewalls 12 and a spoke bed 13, and a number of orifices or spoke fastening holes 14 drilled through the spoke bed 13 and formed or defined and bounded by the peripheral flanges 15, it is preferable that the spoke fastening holes 14 of the spoke bed 13 of the wheel rim 10 are equally spaced from each other and are sized to accept the head 21 of the nipple 20 and the collar 33 of the ferrule 30, 31, 32 for easily and quickly or readily attaching or securing or coupling the spokes 50 to the wheel rim 10, in which the collar 33 of the ferrule 30, 31, 32 is engaged onto a stem 22 that is extended from the head 21 of the nipple 20.

The stem 22 includes an outer diameter smaller than the outer diameter of the head 21 for allowing both the head 21 and the stem 22 to be engaged through the spoke fastening holes 14 of the spoke bed 13 of the wheel rim 10, and the stem 22 includes a threaded hole or screw hole 23 formed therein (FIG. 1) and extended through the center of the nipple 20 to accept or to engage with the threaded portion 51 of the spoke 50 when the complete wheel is assembled. The head 21 includes an outer diameter equals to or slightly smaller than the inner diameter of the spoke fastening holes 14 of the spoke bed 13 of the wheel rim 10. The stem 22 further includes one or more flats 24 formed in the outer portion thereof to mate with a spoke nipple wrench (not shown) so that the nipple 20 may be manually turned in the conventional manner to adjust its threaded assembly with the spoke 50.

The ferrules 30, 31, 32 each include an enlarged casing 34 provided or formed on one end of the respective collar 33 or extended radially and outwardly from the collar 33 and inclined relative to the collar 33, an inner peripheral channel 35 formed in the enlarged casing 34 and formed or defined and bounded by an inner or shorter and inclined peripheral fence 36 and an outer or longer and inclined peripheral fence 37 and an outer peripheral wall 38, and for receiving or accommodating a sealing ring 80 therein, the sealing ring 80 may be retained in the inner peripheral channel 35 of the casing 34 for engaging with the stem 22 of the nipple 20 and for making a water tight seal between the nipples 20 and the ferrules 30, 31, 32, and/or for making a water tight seal between the nipples 20 and the spoke bed 13 of the wheel rim 10. The casing 34 may be engaged with the inner portion of the spoke bed 13 of the wheel rim 10 for anchoring or positioning the ferrules 30, 31, 32 to the spoke bed 13 wheel rim 10.

It is preferable that the ferrules 30, 31, 32 each include an inwardly folded and rounded rim 39 formed in the outer portion or free end portion of the outer or longer and inclined peripheral fence 37 for engaging with the sealing ring 80 and for stably anchoring or retaining the sealing ring 80 within the inner peripheral channel 35 of the casing 34 and for preventing the sealing ring 80 from being disengaged from the inner peripheral channel 35 of the casing 34. It is to be noted that the ferrules 30, 31, 32 may include different casings 34, 34A, 34B (FIG. 1) selectively provided for mating with various driving tools or different spoke ferrule wrench (not shown) so that the ferrules 30, 31, 32 may also be manually turned or rotated in the conventional manner with the driving tools relative to the nipples 20 and the spoke bed 13 of the wheel rim 10 to adjust its position relative to the nipples 20 and the spoke bed 13 of the wheel rim 10.

The collars 33 of the ferrules 30, 31, 32 each include one or more slots 40 longitudinally formed therein and preferably formed through the length of the collar 33, and ended at the adjacent or coupling portion between the collar 33 and the inner or shorter and inclined peripheral fence 36 of the casing 34 of the ferrule 30, 31, 32 for forming or defining one or more blades 41, it is preferable that the slots 40 and the blades 41 are equally spaced from each other. The collars 33 of the ferrules 30, 31, 32 each further include one or more notches or openings 42 formed in the adjacent or coupling portion between the collar 33 and the inner or shorter and inclined peripheral fence 36 of the casing 34 of the ferrule 30, 31, 32 and communicating with the slots 40 respectively for such as preventing or avoiding the stress concentration problems from being occurred or generated. The formation and the provision of the slots 40 in the collar 33 allow the blades 41 to be easily flared or deformed.

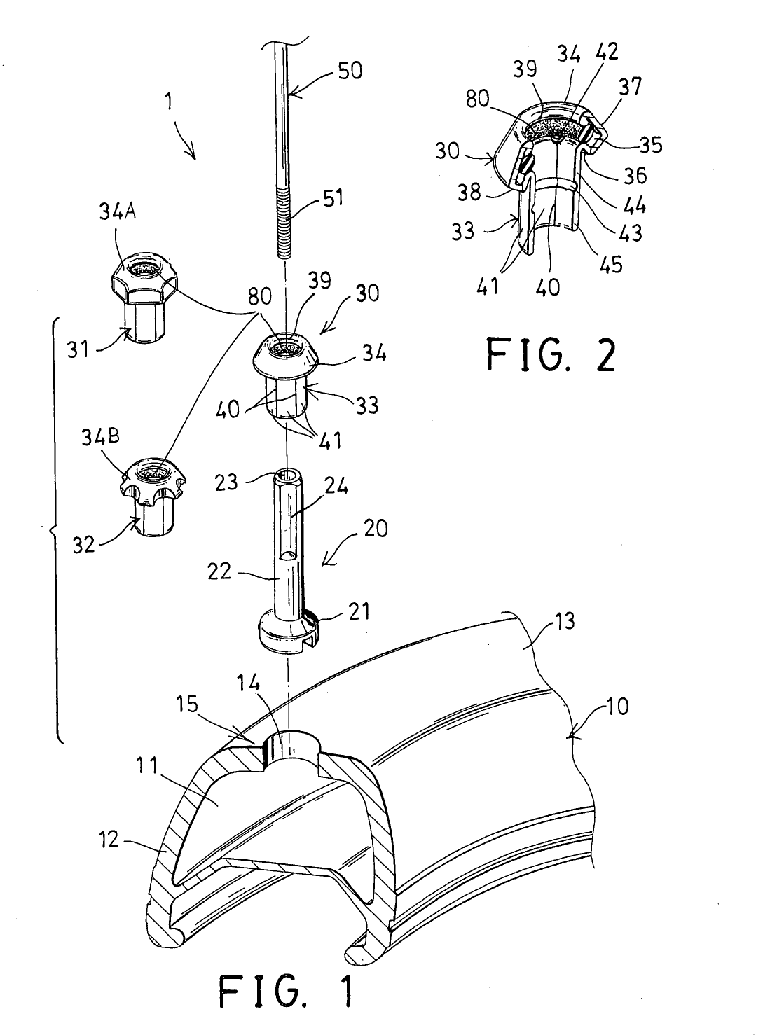

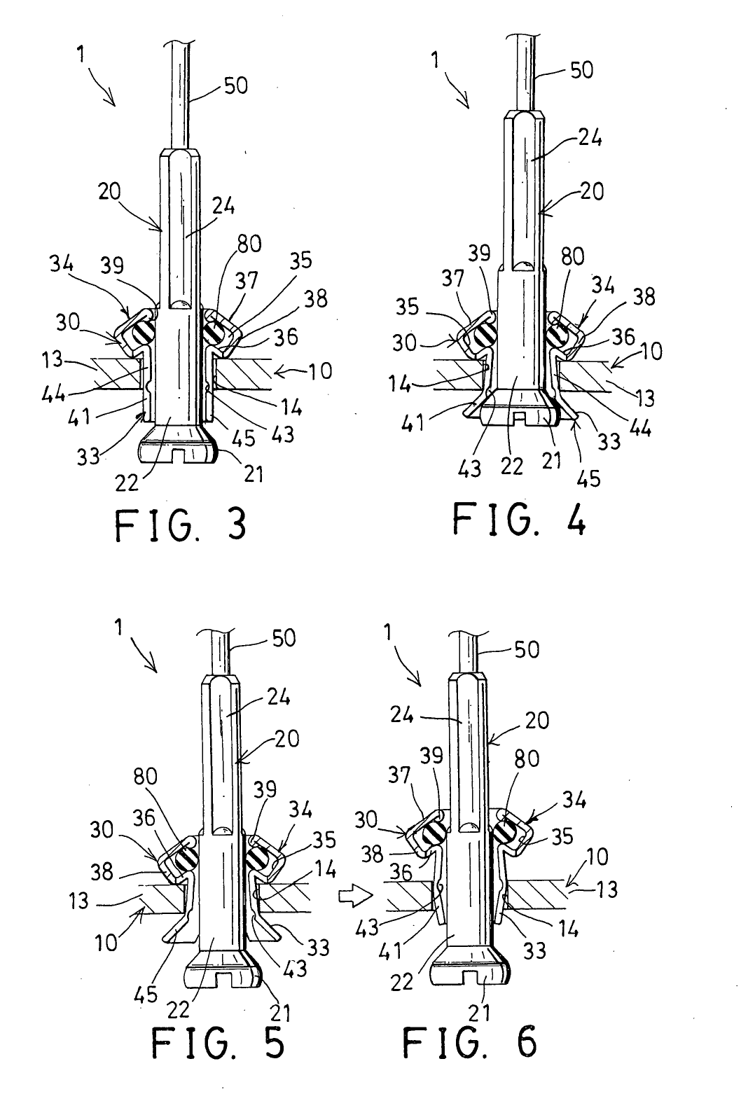

The collars 33 of the ferrules 30, 31, 32 each further include a peripheral groove 43 laterally formed in the inner peripheral portion thereof and formed in the middle portion thereof for forming two cylindrical segments 44, 45 or a middle or first cylindrical segment 44 that is located closer or adjacent to the casing 34, and a free or outer or second cylindrical segment 45 that is located distal to the casing 34, or for separating the collar 33 into two cylindrical segments 44, 45 (FIG. 2), in which the middle or first cylindrical segment 44 substantially equals to or slightly greater than the thickness of the spoke bed 13 of the wheel rim 10 for engaging in the spoke bed 13 of the wheel rim 10 (FIG. 3), and the free or outer or second cylindrical segment 45 will be extended out through the spoke fastening holes 14 of the spoke bed 13 for being engaged with the head 21 of the nipple 20 and for allowing the free or outer or second cylindrical segment 45 flared or deformed to create the flared portion 45 and to engage with the spoke bed 13 of the wheel rim 10 (FIG. 4).

The formation and the provision of the inner peripheral groove 43 of the collar 33 allows the free or outer or second cylindrical segment 45 to be easily and evenly or uniformly flared or deformed or bent relative to the middle or first cylindrical segment 44 in order to create the flared portion 45 and to engage with the spoke bed 13 of the wheel rim 10. The free or outer or second cylindrical segment 45 may also be easily and evenly or uniformly flared or deformed or bent relative to the middle or first cylindrical segment 44 (FIG. 5) when the head 21 of the nipple 20 is disengaged from the free or outer or second cylindrical segment 45, in order to align with the middle or first cylindrical segment 44 (FIG. 6) and to allow the collar 33 of the ferrule 30, 31, 32 to be easily disengaged from the spoke fastening holes 14 of the spoke bed 13 when required, or when the ferrule 30, 31, 32 has been damaged or has to be replaced or changed with the other ones.

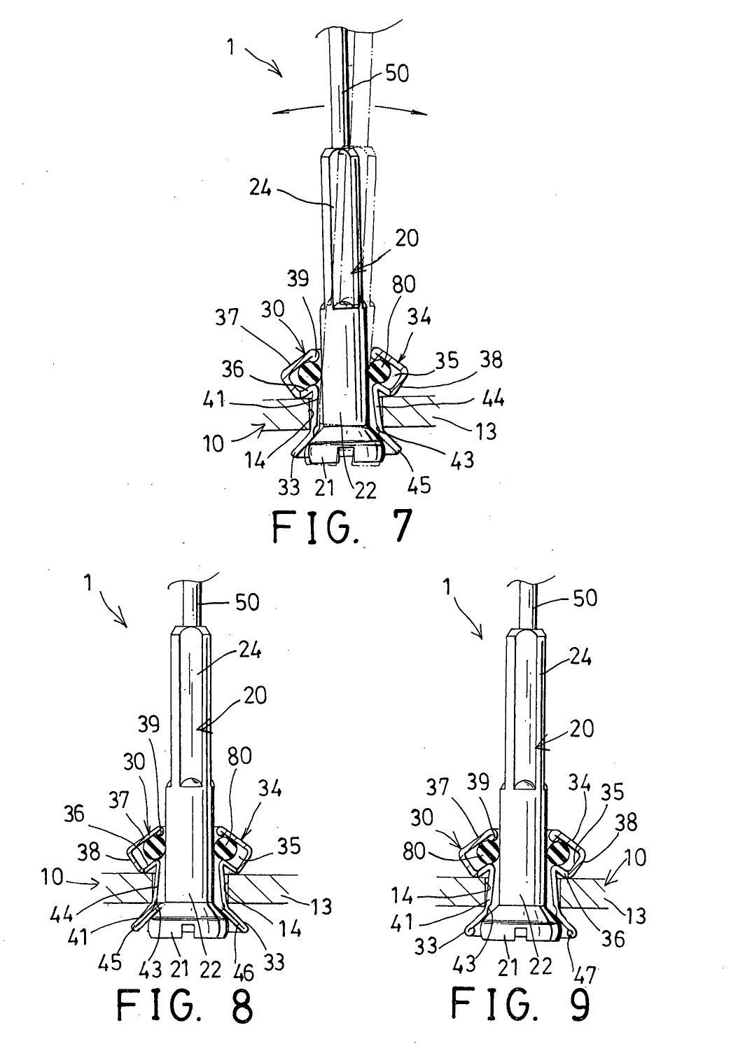

In operation, as shown in FIG. 3, after the head 21 of the nipple 20 and the collar 33 of the ferrule 30, 31, 32 are engaged through the spoke fastening holes 14 of the spoke bed 13, the head 21 of the nipple 20 may be pulled or forced toward the spoke bed 13 by the spoke 50 (FIG. 4) in order to flare or deform the second cylindrical segment 45 and to engage with the peripheral flanges 15 of the spoke bed 13, and to secure the nipple 20 and the ferrules 30, 31, 32 and the spoke 50 to be firmly secured to the spoke bed 13. As shown in FIG. 7, the nipple 20 is allowed to be slightly tilted or inclined relative to the ferrule 30, 31, 32 and/or the spoke bed 13 of the wheel rim 10, and the sealing ring 80 may still be suitably engaged with the stem 22 of the nipple 20 for making the water tight seal between the nipples 20 and the ferrules 30, 31, 32, and/or for making the water tight seal between the nipples 20 and the spoke bed 13 of the wheel rim 10.

It is further to be noted that the casing 34, particularly the inner or shorter and inclined peripheral fence 36 of the casing 34 may be inclined relative to the collar 33 and the spoke bed 13 of the wheel rim 10 and may be in line engagement with the spoke bed 13 of the wheel rim 10 or may be suitably or sealingly engaged with the spoke bed 13 of the wheel rim 10 (FIGS. 3-5, 7-9). The slots 40 of the collar 33 are extended toward the adjacent or coupling portion between the collar 33 and the inner or shorter and inclined peripheral fence 36 of the casing 34 of the ferrule 30, 31, 32, but do not extended or formed through the inner or shorter and inclined peripheral fence 36 of the casing 34, As shown in FIG. 8, the ferrules 30, 31, 32 each may further include a flap 46 infolded or deformed or bent relative to the free or outer or second cylindrical segment 45 and superposed or engaged with the free or outer or second cylindrical segment 45; or alternatively, as shown in FIG. 9, the flap 47 may include a length shorter than the flap 46 as shown in FIG. 8.

Accordingly, the spoke fastening device in accordance with the present invention includes a structure for being easily installed to or disengaged from the vehicle wheel by the users themselves, and including a water tight seal structure.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A spoke fastening device comprising:
a wheel rim including a spoke bed, and a spoke fastening hole drilled through said spoke bed and bounded by a peripheral flange,
a nipple including a head, and a stem extended from said head and having an outer diameter smaller than an outer diameter of said head, both said head and said stem being engageable through said spoke fastening hole of said spoke bed of said wheel rim, said nipple including a threaded hole formed therein,
a ferrule including a collar engaged onto said nipple, and including a casing extended radially and outwardly from one end of said collar for engaging with said spoke bed of said wheel rim and for anchoring said ferrule to said spoke bed of said wheel rim and for allowing said ferrule to be rotated relative to said nipple and said spoke bed of said wheel rim, and including an inner peripheral channel formed in said casing, said collar including a first cylindrical segment adjacent to said casing and engaged in said spoke fastening hole of said spoke bed of said wheel rim, and including a second cylindrical segment located distal to said casing and extended out through said spoke fastening hole of said spoke bed, said head of said nipple being engageable with said second cylindrical segment for flaring and deforming said second cylindrical segment to engage with said spoke bed of said wheel rim, and said ferrule including at least one slot longitudinally formed in said collar for forming at least one blade in said collar, and
a spoke including a threaded portion engaged with said threaded hole of said nipple for forcing said head of said nipple to engage with and to flare said second cylindrical segment.

2. The spoke fastening device as claimed in claim 1, wherein said collar includes a peripheral groove formed therein for forming said first and said second cylindrical segments and for separating said first and said second cylindrical segments from each other.

3. The spoke fastening device as claimed in claim 1, wherein said casing of said ferrule includes an inner and inclined peripheral fence and an outer and inclined peripheral fence for forming said inner peripheral channel of said casing.

4. The spoke fastening device as claimed in claim 3, wherein said inner and inclined peripheral fence of said casing is inclined relative to said spoke bed of said wheel rim and in line engagement with said spoke bed of said wheel rim.

5. The spoke fastening device as claimed in claim 3, wherein said inner and inclined peripheral fence of said casing is inclined relative to said collar.

6. The spoke fastening device as claimed in claim 1, wherein said at least one slot of said ferrule is formed through a length of said collar and ended at an adjacent portion between said collar and said inner and inclined peripheral fence of said casing.

7. The spoke fastening device as claimed in claim 6, wherein said ferrule includes an opening formed in the adjacent portion between said collar and said inner and inclined peripheral fence of said casing and communicating with said at least one slot of said ferrule.

8. The spoke fastening device as claimed in claim 1, wherein said nipple includes at least one flat formed in an outer portion thereof.

9. The spoke fastening device as claimed in claim 1, wherein said ferrule includes a flap bent relative to said second cylindrical segment and engaged with said second cylindrical segment.

10. The spoke fastening device as claimed in claim 1 further comprising a sealing ring engaged in said inner peripheral channel of said casing for engaging with said stem of said nipple and for making a water tight seal between said nipple and said ferrule.

11. The spoke fastening device as claimed in claim 10, wherein said casing of said ferrule includes an inwardly folded rim engaged with said sealing ring and for anchoring and retaining said sealing ring within said inner peripheral channel of said casing.
